(19) United States
(12) Patent Application Publication
(10) Pub. No.: US 2023/0016842 A1
(43) Pub. Date: Jan. 19, 2023

(54) TOUCHPAD MACHINE CONTROL

(71) Applicant: CNH Industrial America LLC, New Holland, PA (US)

(72) Inventors: Mark A. Eckelberg, West Fargo, ND (US); Alexander Schmeling, West Fargo, ND (US)

(73) Assignee: CNH Industrial America LLC, New Holland, PA (US)

(21) Appl. No.: 17/376,891

(22) Filed: Jul. 15, 2021

(51) Int. Cl. E02F 9/20; E02F 9/26; G06F 3/0488

(52) U.S. Cl. CPC E02F 9/2025; E02F 9/2012; E02F 9/265; G06F 3/0488

(57) ABSTRACT

A work equipment for controllably performing work, includes: a work mechanism; a touch-sensitive device configured to output a desired position signal corresponding to a desired position of the work mechanism, the touch-sensitive device selectively operatively including a virtual mechanical control associated with producing the desired position signal; and a controller operatively coupled to the touch-sensitive device and the work mechanism, the controller configured to output an adjustment signal to the work mechanism to adjust an actual position of the work mechanism based at least partially on the desired position signal, the touch-sensitive device being configured to output the desired position signal to the controller when at least one control object is moved along the touch-sensitive device with respect to the virtual mechanical control in a manner that mimics operating a mechanical control.

### FIELD OF THE INVENTION

The present invention pertains to work equipment, and, more specifically, to equipment operator controls.

### BACKGROUND OF THE INVENTION

Work machines are often employed to perform work efficiently. Such work machines, which can also be referred to as work equipment, include construction, agricultural, and forestry machines. More specifically, these machines include wheel loaders, excavators, dozers, motor graders, compaction machines, backhoe loaders, tractors, harvesters, forwarders, and swing machines. Each of these is used to controllably perform work using various mechanical controls.

Wheel loaders, for example, employ mechanical levers (dual or single axis) to control, for example, boom and bucket movement and may include switches, buttons, and/or rollers, either on or near the levers or otherwise about the operator's work station, such switches, buttons, and/or rollers for controlling functions such as ground speed, horn, direction, and other auxiliary functions. Such mechanical controls are controller area network (CAN) based mechanical systems with electronic hydraulic valves. Stated another way, the electro-hydraulic controls are typically CAN-based, but the user input is mechanical.

While such mechanical controls have served well, designing a machine to match every operator's skill level and preferences is demanding. For example, designing a wheel loader with the correct lever force, lever throw, and ergonomics, to match every operator's skill level is challenging. Further, one operator may prefer using a joystick (a dual-axis lever), while another may prefer using single-axis levers. Of those in the latter group, some may prefer using a configuration with two single-axis levers (2SAL), while others may prefer using a configuration with three single-axis levers (3SAL). Converting one CAN-based mechanical lever system (for example, the joystick) for another CAN-based mechanical lever system (for example, 2SAL) can require expensive kits.

What is needed in the art is a control system for work equipment for controllably performing work that is flexible and efficient so as to easily match operator preferences and skills.

### SUMMARY OF THE INVENTION

The present invention provides a control system for work equipment for controllably performing work that is flexible and efficient so as to easily match operator preferences and skills.

The invention in one form is directed to a control system of a work equipment for controllably performing work, comprising: a touch-sensitive device configured to output a desired position signal corresponding to a desired position of a work mechanism of the work equipment, the touch-sensitive device selectively operatively including a virtual mechanical control associated with producing the desired position signal; and a controller operatively coupled to the touch-sensitive device and configured to operatively couple to the work mechanism, the controller configured to output an adjustment signal to the work mechanism to adjust an actual position of the work mechanism based at least partially on the desired position signal, the touch-sensitive device being configured to output the desired position signal to the controller when at least one control object is moved along the touch-sensitive device with respect to the virtual mechanical control in a manner that mimics operating a mechanical control. Further, the controller can be configured to selectively control a boom and a bucket of the work equipment formed as a wheel loader, the mechanical control being one of a first mechanical control including a dual-axis joystick, a second mechanical control including two single-axis levers, and a third mechanical control including three single-axis levers, the virtual mechanical control selectively being one of a first virtual mechanical control corresponding to the first mechanical control, a second virtual mechanical control corresponding to the second mechanical control, and a third virtual mechanical control corresponding to the third mechanical control.

The invention in another form is directed to a work equipment for controllably performing work, comprising: a work mechanism; a touch-sensitive device configured to output a desired position signal corresponding to a desired position of the work mechanism, the touch-sensitive device selectively operatively including a virtual mechanical control associated with producing the desired position signal; and a controller operatively coupled to the touch-sensitive device and the work mechanism, the controller configured to output an adjustment signal to the work mechanism to adjust an actual position of the work mechanism based at least partially on the desired position signal, the touch-sensitive device being configured to output the desired position signal to the controller when at least one control object is moved along the touch-sensitive device with respect to the virtual mechanical control in a manner that mimics operating a mechanical control. Further, the work equipment can be a wheel loader, the work mechanism including a boom and a bucket coupled with the boom, the controller configured to selectively control the boom and the bucket, the mechanical control being one of a first mechanical control including a dual-axis joystick, a second mechanical control including two single-axis levers, and a third mechanical control including three single-axis levers, the virtual mechanical control selectively being one of a first virtual mechanical control corresponding to the first mechanical control, a second virtual mechanical control corresponding to the second mechanical control, and a third virtual mechanical control corresponding to the third mechanical control.

The invention in yet another form is directed to a method of controllably performing work by a work equipment, the method comprising the steps of: outputting, by a touch-sensitive device, a desired position signal corresponding to a desired position of a work mechanism of the work equipment, the touch-sensitive device selectively operatively including a virtual mechanical control associated with producing the desired position signal; outputting, by a controller operatively coupled to the touch-sensitive device and the work mechanism, an adjustment signal to the work mechanism and thereby adjusting an actual position of the work mechanism based at least partially on the desired position signal; and moving at least one control object along the touch-sensitive device with respect to the virtual mechanical control in a manner that mimics operating a mechanical control and thereby outputting, by the touch-sensitive device, the desired position signal to the controller. Further, the work equipment can be a wheel loader, the work mechanism including a boom and a bucket coupled with the boom, the controller selectively controlling the boom and the bucket, the mechanical control being one of a first mechanical control including a dual-axis joystick, a second mechanical control including two single-axis levers, and a third mechanical control including three single-axis levers, the method further comprising the step of selecting, as the virtual mechanical control, one of a first virtual mechanical control corresponding to the first mechanical control, a second virtual mechanical control corresponding to the second mechanical control, and a third virtual mechanical control corresponding to the third mechanical control.

An advantage of the present invention is that it provides a way for operators of varying degrees of skill and preferences to use a single device that can be adjusted to match their skill and preferences.

Another advantage is that it avoids expensive conversion kits to convert one to different types of mechanical controls by, according to an exemplary embodiment of the present invention, combining conventional mechanical controls into a single CAN-based touchpad.

Yet another advantage of the present invention is that it, according to an exemplary embodiment of the present invention, combines mechanical levers, switches, and buttons into a customizable and configurable CAN touchpad.

### BRIEF DESCRIPTION OF THE DRAWINGS

For the purpose of illustration, there are shown in the drawings certain embodiments of the present invention. It should be understood, however, that the invention is not limited to the precise arrangements, dimensions, and instruments shown. Like numerals indicate like elements throughout the drawings. In the drawings:

FIG. 1 illustrates a perspective view of an exemplary embodiment of a wheel loader, the wheel loader including a work mechanism and a control system, in accordance with an exemplary embodiment of the present invention;

FIG. 2 illustrates a perspective view of another exemplary embodiment of the work mechanism including an alternative embodiment of a bucket of the work mechanism, in accordance with an exemplary embodiment of the present invention;

FIG. 3 illustrates a perspective view of a conventional mechanical control, formed as a joystick, used in a wheel loader;

FIG. 4 illustrates a perspective view of another conventional mechanical control, formed as two single-axis levers, used in a wheel loader;

FIG. 5 illustrates a perspective view of another conventional mechanical control, formed as three single-axis levers, used in a wheel loader;

FIG. 6 illustrates a touchpad of the control system of FIG. 1, the touchpad being on a mounting structure, in accordance with an exemplary embodiment of the present invention;

FIG. 7 illustrates display features of the touchpad device of FIG. 6, in accordance with an exemplary embodiment of the present invention;

FIG. 8 illustrates display features of the touchpad device of FIG. 6, in accordance another exemplary embodiment of the present invention;

FIG. 9 illustrates a perspective view of another exemplary embodiment of a wheel loader, the wheel loader including work mechanisms and a control system, in accordance with an exemplary embodiment of the present invention;

FIG. 10 illustrates a schematic diagram of the control system of the wheel loader of FIGS. 1 and 9, the control system including touchpad, in accordance with an exemplary embodiment of the present invention; and

FIG. 11 illustrates a flow diagram showing a method of controllably performing work, in accordance with an exemplary embodiment of the present invention.

### DETAILED DESCRIPTION OF THE INVENTION

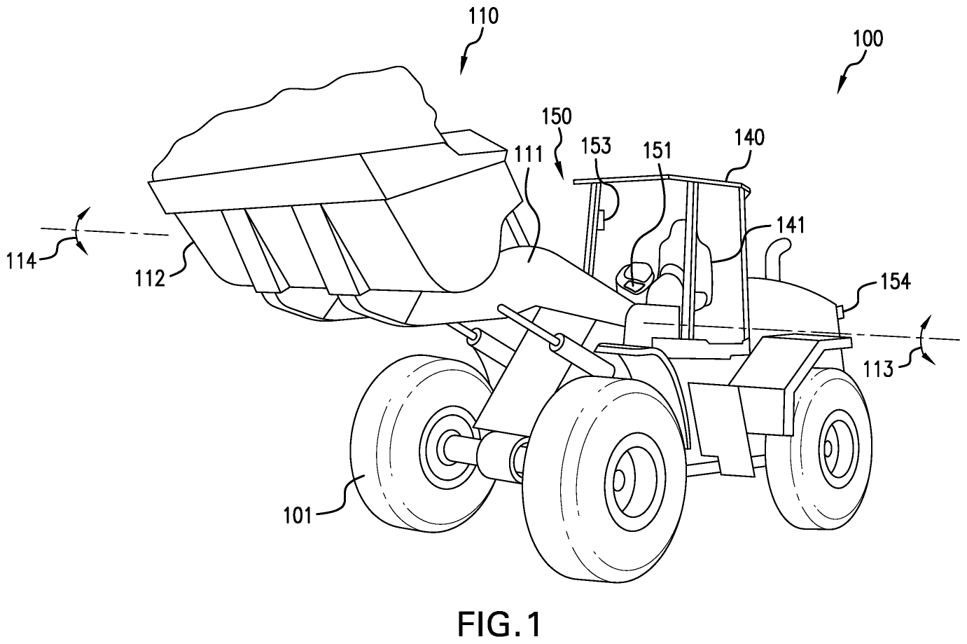

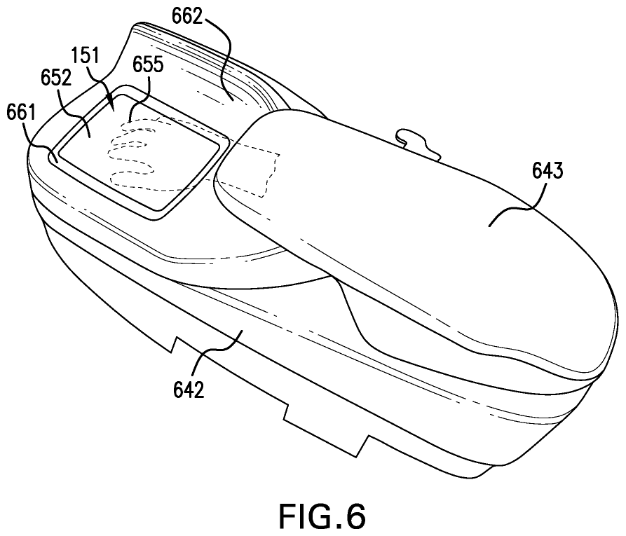

Referring now to the drawings, and more particularly to FIG. 1, there is shown a wheel loader 100 which generally includes wheels 101, a work mechanism 110 including a boom 111 and a bucket 112 rotatably coupled with boom 111, a cab 140 enclosing an operator's work station 141, and a control system 150. Boom 111 is controllably hydraulically operated and is configured to rotate about a transverse axis which is transverse to a longitudinal extent of wheel loader 100 (the fore and aft portions of wheel loader 100 forming the longitudinal extent therebetween of wheel loader 100, fore corresponding to a forward direction of travel of work mechanism 110 during operation), as indicated by a bi-directional arrow 113. Boom 111 is thereby configured to raise and lower bucket 112, in accordance with operator controls from cab or remotely, or autonomously. Bucket 112 is also controllably hydraulically operated and connected to boom 111 such that it can rotate relative to boom 111 about another transverse axis which is transverse to the longitudinal extent of wheel loader 100, as indicated by bi-directional arrow 114. Bucket 112 is thereby configured to curl (that is, to roll back) and to dump (to roll forward) loads from a well of bucket 112, in accordance with operator controls from cab 140 or remotely, or autonomously. Within cab 140 is operator's work station 141, which partially includes control system 150. Control system 150 includes a touchpad 151 (schematically shown in FIG. 1) mounted to a structure 642 (such as part of an armrest or other support) forming part of work station 141, such that touchpad 151 is positioned readily available to the right arm and hand of an operator, according to an exemplary embodiment of the present invention; thus, operator's workstation 141 includes touchpad, which itself includes a touch-sensitive device 652 (FIG. 6)(the layer(s) of pad or screen of a touchpad upon which a user interfaces with touchpad) configured for sensing operator inputs (below). As discussed herein below, touchpad 151 can have display characteristics. Control system 150 can further include a display apparatus 153 (e.g., a monitor or television screen by which text or images can be projected, which itself can be a touchpad) within cab 140 and a rearview camera 154 connected to a rear portion of wheel loader 100 in any suitable location (schematically shown in FIG. 1). Display apparatus 153 can, for instance, be configured by the operator to show a view provided by the rearview camera 154, thereby aiding the operator when wheel loader 100 traverses the ground in reverse.

It will be appreciated that FIG. 1 provides exemplary embodiments of aspects of the present invention. That is, wheel loader 100 is an exemplary embodiment of a work equipment for controllably performing work, according to the present invention. The work equipment of the present invention could be, for example, a construction, agricultural, or forestry machine, such as an excavator, a dozer, a motor grader, a compaction machine, a backhoe loader, a tractor, a harvester, a forwarder, or a swing machine, or another device using hydraulics and a joystick or other mechanical lever controls. Boom 111 and bucket 112 together form an exemplary embodiment of work mechanism 110 for wheel loader 100, according to the present invention. Work mechanism 110 of wheel loader 100 optionally can include a grapple, forks, claws, brooms, snowplows, or any number of different attachments in addition to, or in the alternative to, the bucket. Another work mechanism, according to another embodiment of the work equipment of the present invention, includes a boom, a stick, and a bucket of an excavator.

Boom 111 and bucket 112 of wheel loader 100 can be controlled electro-hydraulically, according to an exemplary embodiment of the present invention. As such, control system 150 can be CAN-based, wherein, for example, touchpad 151 forms a node, an electronic control unit, in the CAN bus system forming control system 150, according to an exemplary embodiment of the present invention. Alternatively, or by combination thereof, work mechanism 110 can be controlled by hydraulic pilot system, in connection with touchpad 151.

Further, touchpad 151 is a device that senses pressure and movement of at least one control object 655 (FIG. 6) over a surface of touchpad 151, that surface being formed by touch-sensitive device 652 herein. Control object 655 is, for example, a portion of a hand of a human being, such as a digit including a finger or a thumb, or a portion of a palm, or another suitable object, such as a touchscreen stylus or a glove such as a touchscreen glove (which can include, for example, conductive threads therein). Herein, control object 655 is referred to as finger(s) 655 (unless otherwise noted), but it will be appreciated that any suitable object for stimulating touch-sensitive device 652 can serve as control object 655. Further, herein unless otherwise noted, finger 655 and thumb 655 can include respectively a finger 655 or thumb 655 wearing a glove. Touchpad 151 is an exemplary embodiment of the present invention, as is touch-sensitive device 652 which is included in touchpad 151. Unless stated otherwise, touchpad 151 includes display characteristics (optionally, however, touchpad 151 could be formed so as not to have display characteristics, a visual associated with touchpad being, in that case, provided on display apparatus 153). Because touchpad 151 includes display characteristics (like a computer monitor), touchpad 151 could be labeled a touchscreen. However, because touchpad is used by the operator to move work mechanism 110, according to an embodiment of the present invention, touchpad 151 is referred to herein as a touchpad. Further, touchpad 151 can be configured as a multi-touch touchpad, such that touchpad 151 responds to a single touch or a plurality of simultaneous touches (such as, for example, two, three, or four fingers, and/or a thumb, and/or a portion of the palm). Touchpad 151 may function according to any suitable technology, such as, for instance, capacitive sensing, or resistive touchscreen. Touchpad 151 can be made of any suitable material and by any method of manufacture known to those skilled in the art.

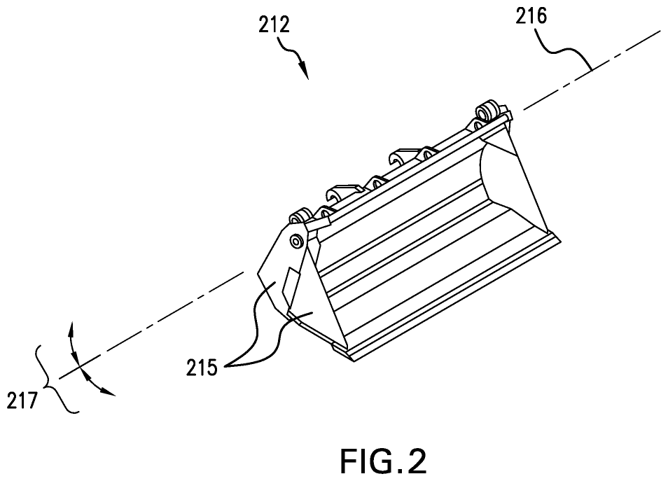

Referring now to FIG. 2, there is shown an alternative embodiment of the bucket of the wheel loader 100, in accordance with another embodiment of the present invention. Bucket 112 can be switched out and bucket 212 can be substituted in its place, using any necessary coupler. Bucket 212 in FIG. 2 includes an additional function. More specifically, bucket 212 can open and close like a mouth. Bucket has two jaws 215 which can rotate about an additional transverse axis shown at 216 and thereby move toward and away from one another, as indicated by bi-directional arrows 217; alternatively, one jaw 215 remains stationary while the other moves about axis 216, which would dispose then of one of bi-directional arrows 217. Jaws 215 are also controllably hydraulically operated in accordance with operator controls from cab 140 or remotely, or autonomously (including, but not limited to, when virtual mechanical controls are in a 3SAL configuration, below). Accordingly, left jaw 215 (in FIG. 2) can be configured to curl and dump according to a mechanical control that would typically control the bucket as in FIG. 1, while right jaw 215 can be configured to open and close, as indicated by the lower arrow 217, by another mechanical control.

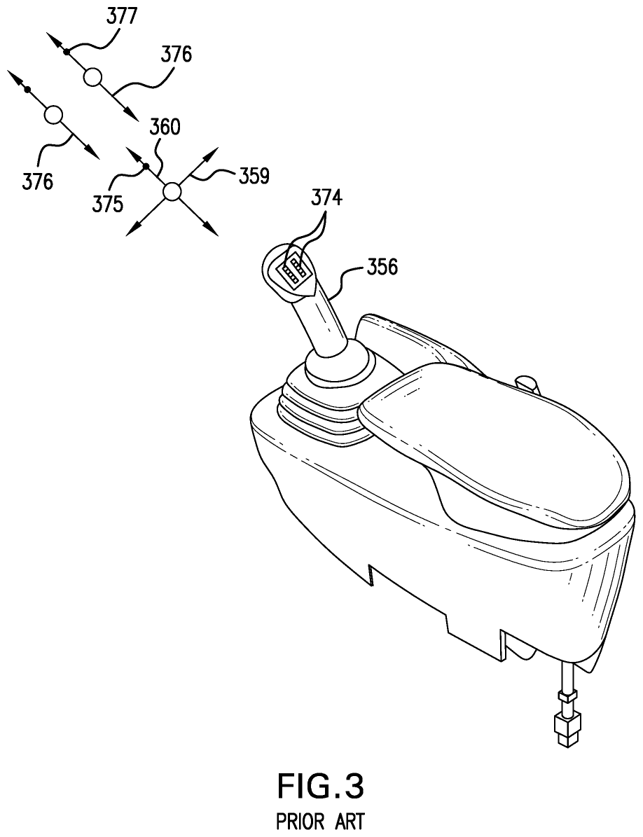

Referring now to FIGS. 3-5, there are shown three separate conventional mechanical controls 356, 457, 558. Each operates by way of a mechanical input by an operator and is part of an operator's work station in the cab of a wheel loader, such as on or near a distal end of an armrest. Further, though not shown, the controls 356, 457, 558 in FIGS. 3-5 are understood to operate a boom and a bucket of a wheel loader, or any other attachments to the wheel loader. FIG. 3 illustrates a conventional mechanical dual-axis control formed as a joystick 356. Joystick 356 is moved by an operator about two perpendicular axes 359, 360 and can be spring-loaded to return to a neutral position at the connection point of axes 359, 360. When joystick 359 is in neutral, the associated boom and bucket hold their respective positions, this neutral position (which can also be referred to as a hold position, neutral position and hold position being used interchangeably herein) being shown by the circle at the center of axes 359, 360. Regarding axis 360, pushing joystick 356 forward (generally, up and to left on the page of FIG. 3) out of neutral causes the boom to go down and thereby lower the bucket; conversely, pulling joystick 356 aft out of neutral causes the boom to go up and thereby lift the bucket. Regarding axis 359, moving joystick 356 to the left causes the bucket to curl, in order to hold a load in the bucket; moving joystick 356 to the right causes bucket to dump in order to dump a load out of the bucket. Joystick 356 can also be moved angularly with respect to axes 359, 360. For example, moving joystick 356 into the northeast quadrant (to the right on axis 359, and up on axis 360) causes the boom to go down and the bucket to dump. Moving joystick 356, for example, forward to its fullest extent opens the hydraulic valving fully, thereby causing boom to move down at maximum speed. The same applies to each of the other three primary directions of joystick 356. Conversely, moving joystick 356, for example, forward only slightly opens the hydraulic valving only slightly, thereby causing boom to move downward at a very slow speed. Gradations of speed, then, exist between the maximum extent of joystick movement in any given direction and the corresponding minimum extent necessary to cause the boom or bucket to move at all. Further, joystick 356 can include an auxiliary mechanical control at the top of the stick, such as a roller 374, which can be used to control additional functions and which function similar to single-axis levers, such as in terms of being bi-directional, as indicated by axes 376. Such functions can include, for example, the opening and closing of the mouth of bucket 212 formed by jaws 215, rolling roller 374 in one direction from a neutral position (which functions as a hold position) of roller 374 causing right jaw 215 to open, rolling roller 374 in the opposite direction from the neutral/hold position causing right jaw 215 to close. Left roller 374 in FIG. 3 can, for instance, control right jaw 215. Further, speed of the associated functions can correspond to the speed of the rolling of roller 374. Further, joystick 356 can include a second auxiliary mechanical control, such as another roller 374, as shown in FIG. 3, which can be used to control additional functions. For example, operation of a broom on wheel loader 100 could include four mechanical controls: (1) raising/lower boom 111; (2) curling/rolling back broom; (3) pivoting broom about a vertical axis (left roller 374); and (4) rotating bristles of the broom clockwise or counter-clockwise (right roller 374).

Further, joystick 356 can include one or more detents. For example, pushing joystick 356 far forward to a feel point at a certain predetermined limit can automatically cause boom 111 to move to a preset low position (either on the ground or at a predetermined low extent above the ground) and bucket 112 to move to a preset position. This low boom 111 detent position can be a float position, wherein boom 111 rests on the ground by its own weight or rests at a predetermined low level on wheel loader 100 such that boom 111 cannot move any lower but is not inhibited from rising slightly, and bucket 112 can be free (not held at any specific position) or held level with the ground, for example. A low detent position is shown by point 375 in FIG. 3. Similarly, detents can be set (or otherwise programmed) at other angular positions on joystick 356, corresponding to predetermined positions of boom 111 and bucket 112; typically, such detents are at the far end of the range of motion of joystick 356 in any of the four main directions; for instance, in FIG. 3, a high boom 111 detent could be signified on axis 360 by placing a dot at the opposite end of axis 360, opposite detent 375. Further, roller 374, which can be operated by operator's thumb, can spring back to the hold position when operator's thumb releases its grip on roller 374, thereby causing the corresponding functions of the attachment (for example, right jaw 215 in FIG. 2) to hold in place. Further, roller 374 can also include detents, as indicated by point 377, at its respective far ends of a range of motion of roller 374. Roller, for instance, can be moved in one direction to a detent (sensed by a feel point, provided, for example, by a notch), and the right jaw 215 in FIG. 2, for instance, will move to that detent position (for example, extended from left jaw 215) and hold. How detents work in the hydraulic system of wheel loader 100 is well-known in the art and will not be described in further detail.

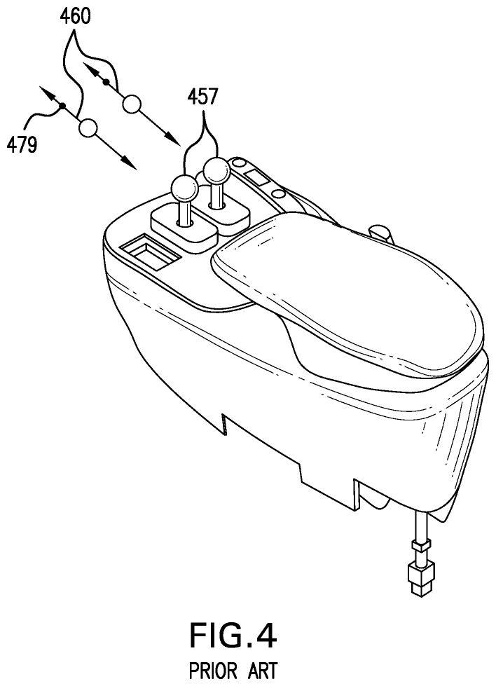

FIG. 4 illustrates conventional mechanical control levers 457, having a 2SAL configuration. These levers 457 are used to lift/lower boom and to curl/dump bucket of a wheel loader. Each lever 457 is moveable fore and aft along their respective parallel axes 460 and can be spring-loaded to return to a neutral position at the middle of their respective full range of movement, the neutral position (which can also be referred to as a hold position) being associated with holding the respective boom or bucket in position and shown by the circle at the center of axes 460. Right lever 457 in FIG. 4 can be used to control the boom, fore being for lowering the boom, aft for raising the boom. Left lever 457 can be used to control the bucket, fore being for dumping the load, and aft for curling the load. The functions of left and right levers 457 can be switched according to an operator's preference, by switching the connections of corresponding hydraulic hoses. Gradations of speed between minimum and maximum speed can be, as described with joystick 356, associated with minimal movement of lever fore or aft (minimal speed), maximum movement fore or aft (maximum speed), and gradations of movement and corresponding gradations of speed therebetween. Detents can also be provided. For instance, a detent at a low boom 111 position, as described above with respect to joystick 356, is indicated by point 479 on right axis 460 in FIG. 4.

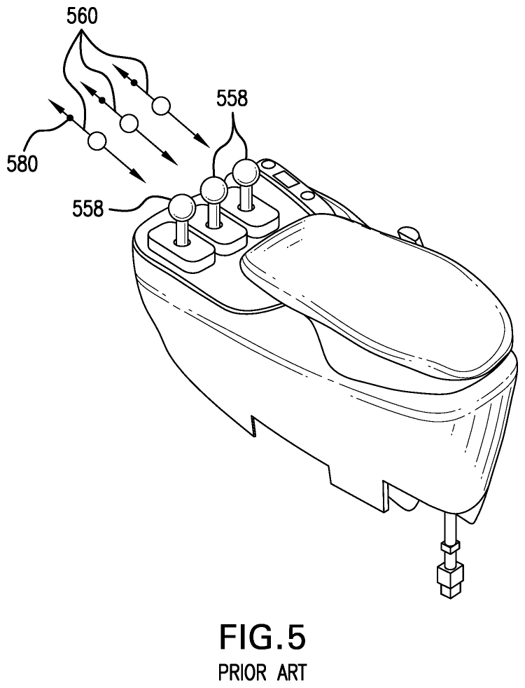

FIG. 5 illustrates conventional mechanical control levers 558, having a 3SAL configuration. As with the 2SAL configuration, these levers 558 move along parallel axes 560 and have neutral positions that can hold a workpiece in place (shown by the circles at the center of axes 560). These levers 558 are used to lift/lower the boom of a wheel loader, curl/dump the bucket of the wheel loader, and to provide an auxiliary mechanical control associated with the work mechanism. Right-most lever 558 and middle lever 558 can operate respectively like right and left levers 457 in the 2SAL configuration, lifting/lowering the boom and curling/dumping bucket, respectively, and at varying speeds. Left-most lever 558 can be the auxiliary control, associated with, for example, opening and closing jaws 215 of bucket 212 of FIG. 2. For example, fore can be to close jaws 215, and aft can be to open jaws 215, or vice versa. Optionally, hydraulic hose connections can be switched according to an operator's preferences to change the referenced functions one to another. Alternatively, left-most lever 558 can be associated with, for example, moving a grapple (not shown) connected to the bucket of the wheel loader. Detents can also be provided. For instance, a detent at a low boom 111 position, as described above with respect to joystick 356, is indicated by point 580 on right axis 560 in FIG. 5.

Referring now to FIG. 6, there is shown a mounting structure 642 in work station 141 of wheel loader. Mounting structure 642 includes an armrest 643. Touchpad 151 includes a body 661 and a touch-sensitive device 652 mounted to body 661, touch-sensitive device 652 including the surface upon which the operator's fingers 655, for example, move along (such as by a sliding action across the surface) and thereby input commands into touchpad 151, touch-sensitive device 652 also forming a screen by which the operator can see various output data in order to properly operate touchpad 151. FIG. 6 shows touchpad 151 mounted to housing 662 by any suitable way known in the art, such as by way of fasteners, brackets, adhesives, or the like. Further, housing 662 can mount to mounting structure 642 (as shown in FIG. 6) by any suitable way known in the art, such as by way of fasteners, brackets, adhesives, or the like. Mounting structure 642 can include a hole (not shown), in a distal end of mounting structure 642, over which housing 662 mounts. This hole can include any devices used to physically attach housing 662 to mounting structure 642 and can serve as an area by which to make electrical and/or computing connections between touchpad 151 and wheel loader's 100 electrical and/or control system 150. Thus, during mounting of touchpad 151 by way of housing 662 to mounting structure 642, a controller area network packet can be inserted into this hole and can be electrically coupled with a CAN bus of wheel loader 100 and touchpad 151 so that the controller area network packet and touchpad 151 form a single node in control system 150 of wheel loader 100, this packet enabling touchpad 151 to communicate with other nodes of control system 150, such as for example, node(s) of work mechanism 110, according to an exemplary embodiment of the present invention (alternatively, a controller within touchpad 151 can obviate the need for this packet and can itself communicate on the CAN bus). With armrest 643 proximate to touchpad 151, it can be appreciated that operator's right forearm, for example, rests atop armrest 643, while operator's right hand extends over touchpad 151, enabling operator's finger(s) 655, thumb 655, and/or a portion of the palm 655 to touch touchpad 151 and operate same thereby. Alternatively, in terms of mounting touchpad 151 to a mounting structure (for example, mounting structure 642) in cab 140, touchpad 151 can be mounted such that touchpad 151 can be adjusted to meet the operator's preferences. That is, touchpad 151 can be: raised or lowered; moved fore or aft in a horizontal plane, and/or moved laterally left or right in a horizontal plane, or moved in any combination of fore/aft and/or left/right (at any angular disposition within a horizontal plane within a certain radius); pivoted about a vertical axis and thereby angled to the operator's preference (yaw); pivoted about a transversely extending axis and thereby tilted fore or aft to the operator's preference (pitch); pivoted about a longitudinally extending axis and thereby tilted left or right to the operator's preference (roll); and/or any combination thereof, in whole or in part. To facilitate any such adjustments, touchpad 151 can be mounted to the mounting structure by way of one or more brackets (not shown). Further, touchpad 151 can be releasably connected to mounting structure 642, such as by way of a bracket, or in any suitable manner. In this way, various touchpads 151 can be interchangeable with respect to a specific wheel loader 100. For example, touchpad 151 can be moved from one wheel loader 100 to another wheel loader 100, detaching touchpad 151 from one wheel loader 100 and attaching it to another by way of a releasable connection.

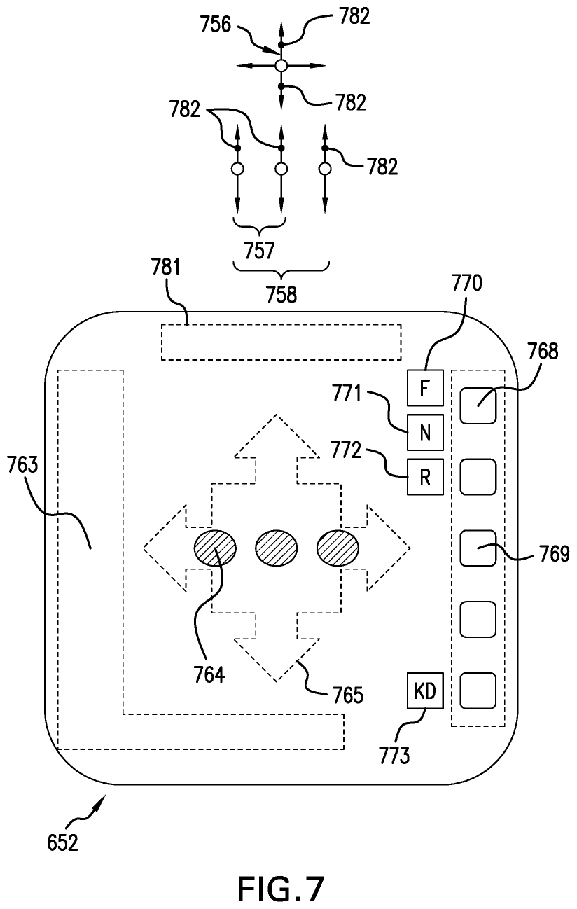

Referring now to FIG. 7, there is shown touchpad 151, more specifically, touch-sensitive device 652 of touchpad 151, by which operator operates touchpad 151, according to an exemplary embodiment of the present invention. Each of the features shown on touch-sensitive device 652 can appear visually once touchpad 151 is activated, either simultaneously or only at times that any such visual features are needed by the operator. The features are shown in FIG. 7 simultaneously to facilitate explanation herein. Proceeding left to right in FIG. 7, there is shown at the left-hand margin a generally L-shaped field 763 in broken lines, in accordance with an exemplary embodiment of the present invention. Field 763 provides a lock/unlock function, depending upon whether or not the operator touches within this field 763. That is, if the operator does not touch within field 763, then operator cannot operate work mechanism 110 by way of touchpad 151, and touchpad 151 is thereby locked from operating work mechanism 110. This serves to prevent unintended touches of touch-sensitive device 652 from operating work mechanism 110. Conversely, when operator is ready to operate work mechanism 110 and touchpad 151 is configured to be in a mode to operate work mechanism 110, operator can place operator's right thumb (generally in the upstanding leg of the L) and a base of operator's right palm (generally in the base of the L) within field 763 (which may or may not be visually marked on pad, virtually or otherwise), thereby unlocking work mechanism virtual mechanical controls 756, 757, 758 of touchpad 151 so that operator can use touchpad 151 to operate work mechanism 110.

Next, in the middle of FIG. 7, three circles 764 and a cross 765 with four arrows are shown. The three circles 764 may appear, but do not necessarily need to appear, virtually on touch-sensitive device 652 to the operator. Circles 764 indicate that one, two, or three fingers 655 of an operator can be used to touch touch-sensitive device 652 and thereby to operate the virtual mechanical controls 756, 757, 758 of work mechanism 110 using touchpad 151. Virtual mechanical controls 756, 757, 758 are shown in FIG. 7 by way of lines (and associated circles therein) exploded from touch-sensitive device 652. Lines associated with virtual mechanical control 756 are crossed (with a circle in the middle) and signify a first virtual mechanical control formed as joystick 756. Lines associated with virtual mechanical control 757 (grouped as two lines exploded from touch-sensitive device 652 in FIG. 7) signify a second virtual mechanical control formed as two levers in a 2SAL configuration. Lines associated with virtual mechanical control 758 (grouped as three lines exploded from touch-sensitive device 652 in FIG. 7) signify a third virtual mechanical control formed as three levers in a 3SAL configuration. Virtual mechanical controls 756, 757, 758 are shown as lines because they do not need to appear on touch-sensitive device 652 and because they indicate the directions of sliding movement of finger(s) 655 that will input a command into control system 150 to adjust work mechanism 110. Though lines associated with controls 756, 757, 758 are exploded from touch-sensitive device 652, it is understood that they could overlay in the central region of touch-sensitive device 652, on or about cross 765, such that horizontal line associated with control 756 is parallel with the x-axis of cross 765 and that vertical lines associated with controls 756, 757, 758 are parallel with the vertical y-axis of cross 765; these lines could be thicker if they appear on touch-sensitive device 652, so as to provide a guide to the operator when operating work mechanism 110. Touchpad 151 is a multi-touch device, according to an exemplary embodiment of the present invention, such that touch-sensitive device 652 can receive more than one input (corresponding to more than one finger 655) at the same time. Regarding cross 765, cross 765 with its four arrows may or may not virtually appear on touch-sensitive device 652 during use, though in an exemplary embodiment of the present invention cross 765 does appear, so as to orient the operator. These arrows are situated on perpendicular x and y-axes as indicated, the x-axis being horizontal (pointing left and right), the y-axis being vertical on the page (pointing up and down). These virtual x and y-axes of cross 765 in FIG. 7 correspond to axes 359, 360 of joystick 356 in FIG. 3, and the y-axis in FIG. 7 corresponds to axes 460, 560 of each lever 457, 558 in 2SAL and 3SAL configurations in FIGS. 4-5. Operator need not move exactly on the lines associated with controls 756, 757, 758 if they were shown on FIG. 7 to operate work mechanism 110; rather, operator can move operator's fingers 655 anywhere generally between field 763 along the left and bottom margins of touch-sensitive device 652, field 781 along the top margin, and auxiliary buttons 768 (discussed below) along the right margin, that is, generally in a central region of touch-sensitive device 652, to operate work mechanism 110. However, regardless of where operator places finger(s) 655 down on touch-sensitive device 652 within this central region, movement along or parallel to x and y-axes of cross 765 of FIG. 7 (within a reasonable margin of error, such as a ten percent deviation) can trigger corresponding movements of work mechanism 110 as with levers 356, 457, 558 in FIGS. 3-5. In an exemplary embodiment of the present invention, cross 765 will appear on touch-sensitive device 652 if joystick 756 is used, and two or three bi-directional arrows can appear in the central region corresponding to two or three single-axis levers, depending upon the operator's selection of a mode of operation. Thus, finger movements on touch-sensitive device 652 (whether for joystick 756, virtual mechanical control (2SAL) 757, or virtual mechanical control (3SAL) 758 provide inputs into touch-sensitive device 652 and thus to control system 150 to control work mechanism 110, that is, the raising/lowering of boom 111, curling/dumping of bucket 112, and/or opening/closing jaws 215 of bucket 212, depending upon which mode of operation the operator selects. Thus, depending upon which mode of operation the operator selects (joystick, 2SAL configuration, of 3SAL configuration), regarding joystick 756 moving finger 655 fore with respect to touch-sensitive device 652 on the vertical line of joystick 756 in FIG. 7 lowers boom 111; moving finger 655 aft on the vertical line of joystick 756 raises boom 111; moving finger right on the horizontal line dumps bucket 112; moving finger left on the horizontal line curls bucket 112. Regarding virtual mechanical control (2SAL) 757, moving right finger 655 (herein, presumed to be fingers of the right hand of operator) fore and aft (as if on the right line associated with 757) lowers and raises boom 111, respectively; and moving left finger 655 fore and aft (as if on the left line associated with 757) dumps and curls bucket 112, respectively. Regarding virtual mechanical control (3SAL) 758, moving right-most finger 655 fore and aft (as if on the right-most line associated with 758) lowers and raises boom 111, respectively; moving middle-finger 655 fore and aft (as if on the middle line associated with 758) dumps and curls bucket 112, respectively; and moving left-most finger 655 fore and aft (as if on the left-most line associated with 758) can close and open jaws 215, or vice versa, respectively. Further, the circle at the intersection of lines associated with joystick 756 signifies neutral position (hold position), as with the circle in lines 359, 360 in FIG. 3; similarly, the circles in lines associated with 2SAL configuration 757 and 3SAL configuration 758 also signify neutral position (hold position). Further, point 782 on lines associated with boom 111 with respect to virtual mechanical controls 756, 757, 758 signify respectively a lower-most detent on boom 111, similar to points in FIGS. 3-5; additional detents could be provided in the software of touchpad 151 or programmed into touchpad 151 according to operator preferences. It will be appreciated that more than three levers can be provided, in accordance with exemplary embodiments of the present invention.

Further, in FIG. 7, at the top margin is field 781, which is configured for displaying information, including but not limited to a mode of operation of wheel loader 100. The mode of operation selectively includes a joystick mode, a 2SAL mode, a 3SAL mode, and any additional auxiliary virtual mechanical controls being used by the operator.

After touching field 763 with operator's thumb and/or a portion of operator's palm, or when otherwise prompted by touchpad 151 to select the mode of operation, operator can trigger the proper mode of operation simply by touching the central region of touch-sensitive device 652 with one, two, or three fingers 655, or, alternatively, within cross 765, according to an exemplary embodiment of the present invention. Touching touch-sensitive device 652 within cross 765 with only one finger 655 causes touchpad 151 to operate in a joystick mode; touching touch-sensitive device 652 with two fingers 655 within cross 765 causes touchpad 151 to operate in a 2SAL mode; and touching touch-sensitive device 652 within cross 765 with three fingers 655 causes touchpad 151 to operate in a 3SAL mode. By simply touching the touch-sensitive device 652 in this way, operator can select one of these three operating modes. According to an exemplary embodiment of the present invention, changing the number of fingers 655 within cross 765 can automatically cause touchpad 151 to change the mode of operation in accordance with however many fingers 655 so touch. Alternatively, rather than simply touching with the appropriate number of fingers 655 on touch-sensitive device 652, touchpad 151 can provide textual, graphic, or auditory prompts leading operator through a decision tree in order to select operator's chosen mode of operation. Once selected, operator can begin operating work mechanism 100. If operator chooses joystick mode, then operator uses one finger 655 on the central region (i.e., within cross 765) of touch-sensitive device 652 to move about the central region and thereby give commands to work mechanism 110, in accordance with lines associated with joystick 757 in FIG. 7. Thus, a single finger operates a virtual joystick 756 of touchpad 151, though joystick 756 may or may not appear visually to operator on touch-sensitive device 652. If operator chooses 2SAL mode, then operator uses two fingers 655 on the central region (i.e., within cross 765) of touch-sensitive device 652 to move about the central region and thereby give commands to work mechanism 110, in the direction of lines associated with virtual mechanical control (2SAL) 757. Thus, two fingers respectively operate two virtual single-axis levers 757 of touchpad 151, though levers 757 themselves may or may not appear visually to operator on touch-sensitive device 652. If operator chooses 3SAL mode, then operator uses three fingers 655 on the central region (i.e., within cross 765) of touch-sensitive device 652 to move about the central region and thereby give commands to work mechanism 110, in the direction of lines associated with virtual mechanical control (3SAL) 758. Thus, three fingers 655 respectively operate three virtual single-axis levers 758 of touchpad 151, though levers 758 themselves may or may not appear visually to operator on touch-sensitive device 652.

Further, operation of virtual controls 756, 757, 758 is similar to operation of mechanical controls 356, 357, 358 not only with respect to movement directions of virtual levers 756, 757, 758 (joysticks 356, 756 are understood to be a type of lever) compared to mechanical levers 356, 357, 358, such operation is also similar with respect to return-to-neutral, operator-regulated speed of work mechanism 110 by way of virtual levers 756, 757, 758, and use of detents. Regarding neutral position (hold position), though touch-sensitive device 652 can have physically or virtually marked thereon lines or positions associated with neutral (hold) position according to an exemplary embodiment of the present invention such that a return-to-neutral (hold) position of the respective levers 756, 757, 758 requires moving the levers 756, 757, 758 back to such neutral positions (hereinafter, hold position) on touch-sensitive device 652, what is now discussed is when the hold position of virtual levers 756, 757, 758 can be formed or occupied simply by lifting a respective finger 655 off of touch-sensitive device 655. That is, when a finger 655 touches touch-sensitive device 652 and moves in specified directions of virtual mechanical controls 756, 757, 758 like mechanical controls 356, 357, 358 in FIGS. 3-5, work mechanism 110 moves in a corresponding direction as discussed. However, to halt movement and to hold boom 111 or bucket 112 in their respective positions, operator need only lift a respective finger 655 off of touch-sensitive device 652, thereby putting respective virtual controls 756, 757, 758 in hold position. This mimicks operation of mechanical controls 356, 357, 358 of FIGS. 3-5, considering that mechanical controls 356, 357, 358 are biased to return to the hold position, such that operator need not intentionally move the respective lever 356, 357, 358 back to neutral. Such a biased return to hold merely requires operator to release or lessen grip on the respective mechanical lever 356, 357, 358. Likewise, returning virtual controls 756, 757, 758 to hold merely requires virtually releasing or lessening the grip on the virtual controls 756, 757, 758, by lifting finger 655 off of touch-sensitive device 652. Regarding speed of movement of work mechanism 110 (boom 111 and bucket 112, 212), with respect to mechanical controls 356, 357, 358 in FIGS. 3-5, as discussed above the speed of work mechanism 110 depends upon the amount of fluid flow of the hydraulic fluid through the valving, which corresponds to how much the operator opens the valving by way of the levers 356, 357, 358; slight movement (short distance out of neutral) of the respective lever 356, 357, 358 from neutral produces slow movement of work mechanism 110, while large movements from neutral produce faster movements of work mechanism 110. Similarly, a small movement (movement of a short distance) of finger 655 across touch-sensitive device 652 opens valving of wheel loader 110 only a small amount, enabling a small volume of hydraulic fluid flow therethrough, thereby moving work mechanism 110 slowly; conversely, a large movement (movement of a long distance) of finger 655 across touch-sensitive device 652 opens valving a greater amount, producing faster movement of work mechanism 110. Further, while the range of movement is fixed with respective to mechanical controls 356, 357, 358 of FIGS. 3-5, the range of movement of virtual mechanical controls 756, 757, 758 are fixed less so. That is, the range of movement of virtual mechanical controls 756, 757, 758 is still limited by a size of touch-sensitive device 652 but could be larger than a corresponding range of movement of mechanical controls 356, 357, 358 of FIGS. 3-5. Even so, as indicated below, operator can set the operator's preferred speed of movement of work mechanism 110 relative to operator's movement of finger(s) 655 on touch-sensitive device 652 (discussed below). Even so, operator can select among three basic settings: fine, moderate, and aggressive. “Fine” means that a large movement of finger 655 across touch-sensitive device 652 results in very small movement of boom 111, bucket 112, 212, or any other function controlled by controls 756, 767, 768. Conversely, “aggressive” (which can also be referred to as a “shake” mode) means that a small movement of finger 655 across touch-sensitive device 652 results in a very large movement of work mechanism 110. “Moderate” is a mid-range between fine and aggressive. Operator can make this selection, for example, by pressing a button (not shown) in field 781 or by pressing a button 768 along the right margin. Regarding detents (as indicated by points 782 in FIG. 7) during operation the operator can send boom 111, for example, to a low-boom 111 detent 782 or a float (regardless of joystick, 2SAL, or 3SAL mode) by sliding finger 655 fore (for example, to a far extent fore) on touch-sensitive device 652 and then double-tapping finger at the end of that sliding movement. Similarly, a high-boom 111 detent 782 can be provided, as shown in FIG. 7, on control 756 by sliding finger 655 aft (for example, to a far extent aft) on touch-sensitive device 652 and then double-tapping finger at the end of that sliding movement. Thus, sliding in the direction of a respective detent and then double-tapping sends work mechanism 110 to the respective detent. Alternatively, similar to the operation of mechanical controls 356, 457, 560, the operator selects a detent by moving the operator's finger, on the respective axis, to the far extent of the range of motion of the respective lever 756, 757, 758 and then double-tapping touch-sensitive device 652 to send the respective part of work mechanism 110 to a position corresponding to the respective detent 782. In this way, virtual mechanical control 756, 757, 758 includes at least one detent configured for being activated when at least one control object 655 slides along and double-taps touch-sensitive device 652. The respective detent 782 can stop, for example, and work mechanism 110 can again move when touchpad 151 senses a subsequent input from the operator, such as a sliding input simulating movement of a joystick or any of the 2SAL or 3SAL levers. Though FIG. 7 shows only one detent 782 at a low boom 111 position with respect to each of virtual mechanical controls 756, 757, 758 and only one detent 782 at a high boom 111 position of control 756, it will be appreciated that other detents could be provided within any other portion of the range of motion of controls 756, 757, 758, such as at a bucket curl position, a bucket dump position, a bucket level position, or any combination or gradation thereof, and with respect to any of controls 756, 757, 758.

With further reference to operator settings, operator can, for example, swipe left across touch-sensitive device 652 to reach a page for operator settings. These can be set before operating work mechanism 110. One such setting is a sensitivity setting corresponding to speed of movement of work mechanism 110. A basic setting corresponds to what is described above, with respect to the operator selecting a mode of fine, moderate, or aggressive. But, these modes themselves can be further refined by the operator, to correspond to operator preferences even more precisely. That is, some operators may prefer to move finger(s) 655 a relatively large distance across touch-sensitive device 652 to achieve a small amount of movement of work mechanism 110. On the other hand, other operators (or the same operators in different circumstances) may prefer to move finger(s) 655 a relatively small distance across touch-sensitive device 652 to achieve a large amount of movement of work mechanism 110. Such a sensitivity setting can be achieved according to an exemplary embodiment of the present invention. For example, a distance could be marked out on a speed setting page of touchpad 151 according to touchpad coding, and the time it takes to traverse that distance by operator's finger 655 could correspond to a speed of movement of work mechanism 110. A slow traversal across that distance could correspond to a slow speed. A fast traversal across that distance could correspond to a fast speed. According to another embodiment of such a sensitivity setting, when prompted by touchpad 151 operator could move operator's finger 655 across touch-sensitive device 652 and thereby mark out a distance corresponding to a full range of movement of a respective virtual lever 756, 757, 758, or a range of movement corresponding to hold position to an outermost extent of a corresponding lever 756, 757, 758 in either direction. Setting a distance in this way for range of movement of virtual lever 756, 757, 758 implicitly then sets speed of work mechanism as well. The fraction of movement across a set range of movement by operator corresponds to a corresponding fraction of maximum speed, as with mechanical levers 356, 357, 358 in FIGS. 3-5. If the operator further refines the operating speed in this manner, touchpad 151 will adjust the meaning of fine, moderate, and aggressive accordingly. On the other hand, the operator need not make such a refined setting and opt to use factory-established speed settings.

Another setting that the operator can make is to fix the mode of operation of wheel loader 110. That is, a default setting can be that wheel loader 100 automatically changes the mode of operation—joystick 756, 2SAL 757, or 3SAL 758—depending upon however many fingers 655 are touching within cross 765. For instance, one finger 655 signifies joystick 756. However, two fingers 655 could signify (a) 2SAL 757 or (b) joystick 756 plus one virtual auxiliary mechanical control 883 (below), such as what is needed to control right jaw 215 in FIG. 2. The ambiguity will be resolved because control system 150 can sense the number of virtual auxiliary mechanical controls that will be needed (for example, by recognizing how many electro-hydraulic valve sections are on work equipment 100), depending upon the attachment that has been attached to a hydraulic system of wheel loader 100. If none are needed (as with bucket 112), then two fingers 655 means (a) 2SAL; if one is needed (as with bucket 212), then two fingers 655 mean (b) joystick 756 plus virtual auxiliary mechanical control 883. Similarly, three fingers 655 could signify (a) 3SAL 758 or (b) joystick 756 plus two virtual auxiliary mechanical controls 883. Again, control system 150 resolves the ambiguity by sensing the number of virtual auxiliary mechanical controls 883 that will be needed. If one virtual auxiliary mechanical control 883 is needed (as with bucket 212), then three fingers 655 mean (a) 3SAL 758. If two virtual auxiliary mechanical controls 883 are needed (as with a broom), then three fingers 655 mean (b) joystick 756 plus two virtual auxiliary mechanical controls 883. That can be the default situation. Further, because control system 150 would allow, for example, with bucket 112 either joystick 756 or 2SAL 757, the operator could readily switch between these two modes of operation simply by changing a deposit on touch-sensitive device 652 from one to two fingers 655, or vice versa, and control system 150 would automatically make the change. Further, operator could change from 2SAL 757 mode to joystick 756 mode by using a single finger 655 and moving finger 655 in a left-right direction on touch-sensitive device 652 outside the margin of error, which could then trigger the mode to change from joystick 756 to 2SAL 757. On the other hand, a specific operator may have some disability in the operator's hand making it difficult to keep the appropriate number of fingers 655 on touch-sensitive device 652, such that inadvertently adding a finger 655, for example, when operating in joystick 756 mode would undesirably cause touchpad 151 to switch to 2SAL 757 mode. Further, a disability could cause operator to inadvertently steer operator's finger 655, for example, outside of a margin of error associated with, for example, an axis associated with 2SAL 757, deviating too much in a left or right direction on touch-sensitive device 652, which touchpad 151 could then interpret as an operator switching from a 2SAL 757 configuration to a joystick 756 configuration, which would be contrary to operator's intent. A solution to both of these types of problems can be to enable operator to fix the mode at the beginning of operation, so that touchpad 151 does not switch from an operator's preferred mode of operation (i.e., 2SAL 757) to another mode of operation (i.e., joystick 756). Such fixing of the mode of operation can occur in prompts when the operator is making operator settings, and such settings can be saved for future use as well for that operator. The mode of operation can be fixed and thus locked in, for example, by pressing a lock-in button when prompted, such as in field 781 or by way of a button 768. If the mode of operation is fixed, then operator can use any number of fingers to operate the virtual mechanical controls (i.e., one, two, three, four fingers 652), whether formed as joystick 756, two levers 757 in 2SAL configuration, three levers 758 in 3SAL configuration, and/or any additional virtual auxiliary mechanical controls 883.

All settings (which can be referred to as personalized settings, operator settings, or personalized operator settings) established by a specific operator can be saved by touchpad 151 so that when operator returns to wheel loader 100 operator need not input personalized settings again. Such personalized settings can be accessed by way of, for example, an operator's thumbprint, or by manually entering an access code into touchpad 151, when prompted. Further, as discussed below, such operator settings are interchangeable from wheel loader 100 to wheel loader 100 (or other work equipment), with the result that a specific operator's personalized settings can follow the operator from one wheel loader 100 to another.

Proceeding further to the right in FIG. 7, there are shown virtual buttons 770, 771, 772, 773 (which can be referred to as icons), according to an exemplary embodiment of the present invention. Virtual buttons 770, 771, 772, 773 can be shown virtually on touch-sensitive device 652 during operation of wheel loader 100. Virtual buttons 770, 771, 772 can include indicia thereon such as respectively “F,” “N,” or “R” as shown in FIG. 7, and the operator can selectively press virtual buttons 770, 771, 772 and thereby place a transmission of wheel loader 100 in forward, neutral, or reverse. When the transmission of wheel loader 100 is in forward or reverse, a speed of wheel loader 100 is determined by a throttle pedal operated by operator, and a gear of wheel loader 100 can be selected automatically by a transmission computer (in an alternative embodiment of the present invention, the gearing can be selectively manually changed by the operator). Further, virtual button 773 is a kick-down button, which the operator can press in order to cause the transmission of wheel loader 100 to shift down through the gears in single steps.

Proceeding still further to the right in FIG. 7 (now to the right-hand margin), five square-like buttons 768 are shown in a vertical array, according to an exemplary embodiment of the present invention. An auxiliary settings page on touch-sensitive device 652 can display icons associated with various auxiliary functions, such as horn operation, viewing of rearview camera 154, payload information corresponding to a payload function 769, and a Bluetooth radio control. An operator, when setting the operator's preferred auxiliary settings, can drag the icon associated with a particular function and drop the icon onto a corresponding button 768, with the result that that button 768 is associated with that function. For example, if operator dropped a horn icon onto a top button 768 in the vertical array in FIG. 7, then pressing down on that button 768 can operate the horn. Further, if operator dropped a rearview camera icon onto the button 768 that is second from the top of the vertical array, then pressing that button 768 can cause the view of rearview camera 154 to be shown on display apparatus 153, which can facilitate the operator's travel in reverse. Further, if operator dropped a payload icon into the third button 768 from the top, then pressing that button 768 could take touchpad 151 to a payload page, which could display additional buttons associated with various information. For instance, such a payload button 768 can correspond to payload function 769 and can provide such information as bucket weight, truck count (how many trucks wheel loader has loaded), total amount of material wheel loader 110 has moved over a period of time, how much material by weight has been placed in a truck as opposed to how much has been placed in a trailer pulled by the truck, thereby enabling operator to obtain a proper weight per bucket 112, 212 and to properly load a variety of containers. Further, operator could, for instance, move a radio icon to the fourth button down in the vertical array and thereby enable operator to control a Bluetooth radio system in operator's work station 141. Thus, touchpad 151 includes a plurality of selectable auxiliary controls (e.g., rearview camera 154, payload function 769, horn, Bluetooth radio), selected by operator. Such auxiliary functions are provided only by way of example, and not by way of limitation.

In summary, mechanical control 356, 457, 558 can be a first mechanical control 356 formed as a dual-axis joystick 356, a second mechanical control 457 formed as two single-axis levers 457, or a third mechanical control 558 formed as three single-axis levers 558. The virtual mechanical control is selectively a first virtual mechanical control 756 corresponding to the first mechanical control 356, a second virtual mechanical control 757 corresponding to second mechanical control 457, or a third virtual mechanical control 758 corresponding to third mechanical control 558. Further, first virtual mechanical control 756 is configured for being controlled by at least one control object 655 which can be a single finger 655, second virtual mechanical control 757 is configured for being controlled by at least one control object 655 which can be two fingers 655, and third virtual mechanical control 758 is configured for being controlled by at least one control object 655 which can be three fingers 655.

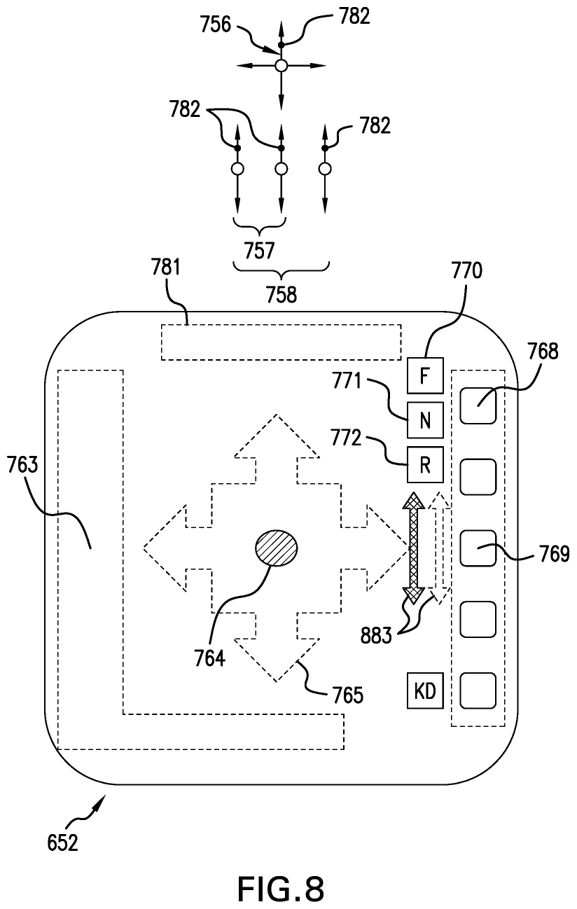

Referring now to FIG. 8, there is shown touchpad 151, more specifically, touch-sensitive device 652 of touchpad 151, by which operator operates touchpad 151, according to another exemplary embodiment of the present invention. In FIG. 8, the operator has already selected a joystick 756 mode of operation from among the options of joystick 756, levers 757 with 2SAL configuration, and levers 758 with 3SAL configuration (alternatively, operator could have selected levers 757 with 2SAL configuration or levers 758 with 3SAL configuration). The embodiment in FIG. 8, however, further includes at least one virtual auxiliary mechanical control 883, in addition to joystick 756 (or, alternatively, levers 757 with 2SAL configuration or levers 758 with 3SAL configuration), two such virtual auxiliary mechanical controls 883 being depicted as arrows in FIG. 8, one in solid lines, the other in broken lines (if levers 758 with 3SAL configuration are selected, then the virtual auxiliary control lever 758 of the three levers 758 constitutes one virtual auxiliary mechanical control 883). It will be appreciated that one, two, or more such virtual auxiliary mechanical controls 883 can be used, though only two are shown in FIG. 8. Virtual auxiliary mechanical controls 883 correspond to auxiliary mechanical controls 374 (roller 374) on the face of joystick 356 in FIG. 3. The left virtual auxiliary mechanical control 883 in FIG. 8 corresponds to the left auxiliary mechanical control 374 in FIG. 3, and the right virtual auxiliary mechanical control 883 in FIG. 8 corresponds to the right auxiliary mechanical control 374 in FIG. 3. It will be appreciated that just as joystick 356 in FIG. 3 may include only one auxiliary mechanical control, joystick 756 in FIG. 8 may be virtually provided with only one virtual auxiliary mechanical control 883. When the attachment, such as bucket 212, is attached to the front of wheel loader 100, control system 150 can sense that one virtual auxiliary mechanical control is needed; thus, touchpad 151 can display a single arrow corresponding to a single virtual mechanical control 883 is needed, when joystick 756 has been selected, as indicated by the left arrow in FIG. 8. Similarly, if a broom is attached to the front of wheel loader 100, control system can sense that two virtual auxiliary mechanical controls 883 are needed; thus, touchpad 151 can display two arrows corresponding to virtual mechanical controls 883 are needed, when joystick 756 has been selected, as indicated by the two arrows in FIG. 8. Further, the operation of virtual auxiliary mechanical controls is like that of the virtual single axis levers 757, 758 described herein, and can include hold position and detents. To operate, the operator moves operator's finger(s) 655 along the arrows associated with virtual auxiliary mechanical controls 883, and another finger 655 to operate joystick 756. As such, joystick 756 and virtual auxiliary mechanical control 883 are configured for being controlled by one finger 655 each.

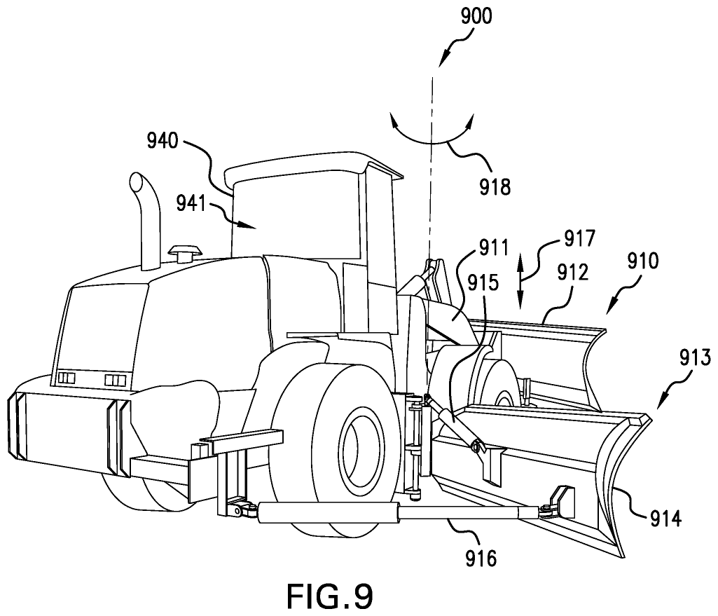

Referring now to FIG. 9, there is shown a wheel loader 900 that includes a boom 911, a snowplow 912 mounted to boom 911, and a snow wing 913 mounted to one side of wheel loader 900. Work mechanism 910 of wheel loader 900 can include boom 911, snowplow 912, and/or snow wing 913 (which can be referred to as a secondary work mechanism 913 that may be considered as a portion of work mechanism 910 or considered separate therefrom). Conventionally, boom 911 and snowplow 912 can be controlled by joystick 356, levers 457 with 2SAL configuration, or levers 558 with 3SAL configuration. Snowplows with additional functions can optionally be attached to the boom of wheel loader 900, for example, snowplows formed with side wings, which can be controlled with additional auxiliary mechanical controls, such as a lever 558 or rollers 374. However, according to an exemplary embodiment of the present invention, boom 911 and snowplow 912, as well as snow wing 913, can be controlled by way of touchpad 151 employing virtual mechanical devices 756, 757, or 758, similar to what is described above, touchpad being within operator's work station 941 (though touchpad 151 is not shown in FIG. 9, it will be appreciated that touchpad 151 can be arranged, positioned, and connected in operator's work station 941 similar to what is shown in, and described with respect to, FIGS. 1 and 6). Thus, boom 911 can be raised/lowered virtually, and snowplow 912 can be curled/dumped virtually, all by way of touchpad 151. Further, snowplow 912 can optionally be pivoted about a vertical axis (not shown) near a transverse midpoint so as to selectively pivot clockwise or counter-clockwise (as from a top view of wheel loader 900) so as to push snow off to the left or right of wheel loader 900. Accordingly, virtual joystick 756 or two virtual levers of 757, 758 can, for example, control raising/lowering of boom 911, and a virtual auxiliary mechanical control formed as one of the levers 758 in 3SAL configuration or a first virtual auxiliary mechanical control 883 can be used to control the pivot of snowplow 912 about the vertical axis. Snowplow 912 is considered, in this example, a primary work mechanism of wheel loader 900; mechanical controls 356, 457, 558, 883, as well as virtual mechanical controls 756, 757, 758, 883, are thus also considered primary, when snow plow 912 is used in conjunction with snow wing 913.

Regarding snow wing 913, snow wing 913 includes a blade 914, a first hydraulic device 915 for raising/lowering blade 914 (as indicated by bi-directional arrow 917), and a second hydraulic device 916 for retracting/extending a distal end (end farthest away from the side of wheel loader 900) of blade 914 as a proximal end of blade is connected so as to be able to pivot about a vertical axis (as indicated by bi-directional arrow 918). Snow wing 913 can be attached to the side of wheel loader 900 in known manner and to the hydraulic system of wheel loader 900 in known manner. Conventionally, snow wing 913 can be controlled by a second joystick in a cab 940, in addition to a first joystick 356, levers 457, levers 558, or rollers 374 for controlling snowplow 912, and in known manner an auxiliary mechanical control 558, 374 can be placed in a detent position (for example, a low-boom 911 detent) so that the second joystick is operative. By way of example and not by way of limitation, the second joystick (not shown) can be configured so as to include four buttons on a face of the second joystick, more specifically, two rows of two buttons each, and these buttons can be configured to operate snow wing 913 as follows: a top left button, when pressed, can cause blade 914 to raise; a bottom left button can lower blade 914; a top right button can swing blade 914 out away from the side of wheel loader 900 (extend); and a bottom right button can swing blade 914 in towards the side of wheel loader 900 (retract). Alternatively, two rollers 374, as in FIG. 3, can substitute for the buttons. Alternatively, the second joystick can be a dual-axis joystick (similar to joystick 356 in FIG. 3) that is configured to move snow wing 913 by moving the second joystick forward/backward, left/right, or any combination thereof. By way of example and not by way of limitation, moving the second joystick forward can cause blade 914 to lower, moving the second joystick backward can cause blade 914 to raise, moving the second joystick left can cause blade 914 to retract, and moving the second joystick right can cause blade 914 to extend. Thus, snow wing 913 is considered a secondary work mechanism, mechanical controls 356, 374 are considered secondary mechanical controls.

However, according to an exemplary embodiment of the present invention, snow wing 913 can be controlled by way of touchpad 151 in place of the second joystick, similar to what is described above. That is, when the operator is operating snow plow 912, the operator can use a page—which can be referred to as Page One—on touch-sensitive device 652 as indicated in FIG. 7 or FIG. 8, the salient factor being that at least one virtual auxiliary control is being used, whether (a) in a 3SAL 758 configuration according to one alternative in FIG. 7 (one of the three levers 758 being a virtual auxiliary mechanical control), (b) in a virtual joystick 756 configuration plus a virtual auxiliary mechanical control 883 in FIG. 8, or (c) in a 2SAL 757 configuration plus a virtual auxiliary mechanical control 883 in FIG. 8. Further, when the operator desires to employ snow wing 913, snow wing 913 is connected to the side of wheel loader 900 and to the hydraulics of wheel loader in known manner. Further, as with the conventional mechanical control described above, a virtual auxiliary mechanical control (whether from the 3SAL 758 configuration in FIG. 7 or a virtual auxiliary mechanical control 883 in FIG. 8) can be placed in a detent position (for example, a low-boom 911 detent) so that virtual lever(s) associated with snow wing 913 are operative, the valving associated with the virtual auxiliary mechanical control rendering snow wing 913 controllable in known manner. When the operator desires to operate snow wing 913, the operator can move to a Page Two on touch-sensitive device 652, by pressing an associated auxiliary button 768 (which can already have been set by the operator to move to Page Two when depressed), by pressing an associated button in field 781, or by swiping across touch-sensitive device up, down, left, or right, when touch-sensitive device 652 is in an operating mode (as opposed to a mode where the operator is establishing settings, such as setting auxiliary buttons 768). Once on Page Two, Page Two can be similar to FIG. 7 or FIG. 8, depending upon how many virtual auxiliary controls are needed. Because snow wing 913 needs only two axes (one to control raising/lowering of snow wing 913, and another to control extension/retraction of snow wing 913), Page Two can be similar to FIG. 7, such that FIG. 7 serves the dual purpose of showing the appearance of both Page One and Page Two, with respect to snow wing 913. In this way, a single finger 655 can be used to control virtual joystick 756 on Page Two as in FIG. 7, such that, for example, moving finger 655 forward on touch-sensitive device 652 when on Page Two can cause blade 914 to lower, moving finger 655 backward can cause blade 914 to raise, moving finger 655 left can cause blade 914 to retract, and moving finger 655 right can cause blade 914 to extend (alternatively, hydraulic hoses can be arranged so that the directions of virtual joystick 756 control different functions). Alternatively, rather than moving virtual levers 756, 757, 758 on Page Two and/or any additional virtual auxiliary mechanical controls 883 (which would be like FIG. 8), Page Two can be configured to display the necessary number of buttons, such as four virtual buttons (not shown) disposed in two rows (as described above with respect to the conventional mechanical second joystick), with the four virtual buttons corresponding to the four mechanical buttons above and thus performing the same functions. Thus, virtual mechanical controls 756, 757, 758, and virtual auxiliary mechanical controls 883, are considered secondary.

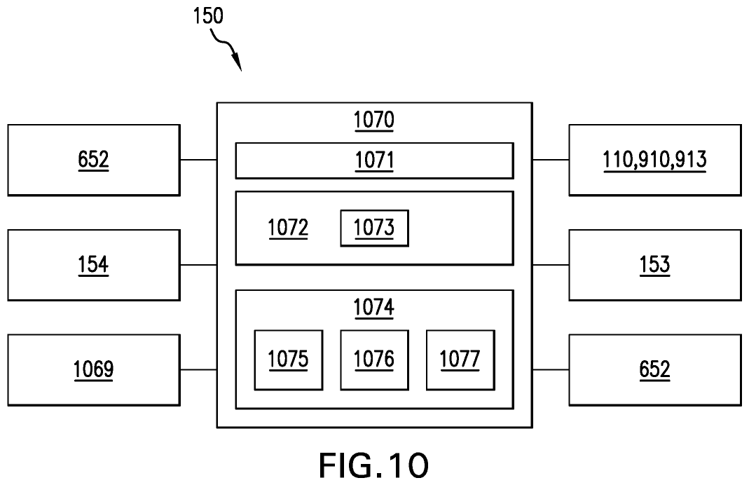

Referring now to FIG. 10, there is shown a schematic diagram of control system 150, according to an exemplary embodiment of the present invention. Control system 150 includes, for example, touch-sensitive device 652 of touchpad 151 (touchpad 151 being included in control system 150), rearview camera 154, payload sensors 1069 of payload function 769, work mechanism 110, work mechanism 910, work mechanism 913, display apparatus 153, and controller 1070. Touchpad 151 includes touch-sensing device 652 which serves as an input device, sensing operator input, and sending that data to controller 1070. Operator can select which virtual mechanical control 756, 757, 758, and/or virtual auxiliary mechanical control 883 to use using touch-sensitive device 652, and/or controller 1070 outputs to touch-sensitive device 652 a number of virtual auxiliary mechanical controls 883 depending upon how many controls are needed to operate work mechanism 110, 910, 913 (such as by sensing the hydraulics or valving associated with the attachments connected to wheel loader 100, 900). Further, touch-sensitive device 652 outputs a desired position signal corresponding to an operator's desired position of work mechanism 110, 910, 913. The desired position signal corresponds to the movement of operator's finger(s) 655 along touch-sensitive device 652 so as to move virtual mechanical controls 756, 757, 758. Thus, touch-sensitive device 652 selectively operatively includes a virtual mechanical control 756, 757, 758 associated with producing the desired position signal. Further, as described in more detail above, touch-sensitive device 652 is configured to output the desired position signal to controller 1070 when at least one control object 655 (for example, finger(s)) is moved along touch-sensitive device 652 with respect to a virtual mechanical control 756, 757, 758, and/or virtual auxiliary mechanical control 883, optionally, in a manner that mimics operating a mechanical control (356, 457, 558, 374 of FIGS. 3-5) with respect to a virtual mechanical control 756, 757, 758, and/or virtual auxiliary mechanical control 883. Rearview camera 154 is an input device that inputs data of a rearview of wheel loader 110, 910, which controller 1070 outputs to show video on display apparatus 153. As discussed above, payload information includes various loading information for operator. For example, payload sensors 1069 associated with, for example, boom 111 and/or bucket 112, 212 to measure load weight and output that data to controller 1070, which can collect that data, store it, and output it to operator in a meaningful display on touch-sensitive device 652 or on display apparatus 153. Thus, controller 1070 is operatively coupled to, for example, touch-sensitive device 652, rearview camera 154, payload sensors 1069, work mechanism 110, 910, 913, and display apparatus 153. Controller 1070 can also be operatively coupled with a variety of other systems of wheel loader 100, 900, such as engine control, steering, and a transmission, to name just a few.

In general, controller 1070 may correspond to any suitable processor-based device(s), such as a computing device or any combination of computing devices. Thus, as shown in FIG. 8, controller 1070 may generally include one or more processor(s) 1071 and associated memory 1072 configured to perform a variety of computer-implemented functions (e.g., performing the methods, steps, algorithms, calculations and the like disclosed herein). For instance, touchpad 151 may include a processor therein, as well as associated memory, data, and instructions, such components (processor, memory, data, instructions) of touchpad 151 forming at least part of controller 1070. Controller 1070 is understood to include the processor 1071 of touchpad 151, such processor 1071 being able to work in conjunction with a local computer area controller to form a node and at least part of controller 1070. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, memory 1072 may generally include memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD), and/or other suitable memory elements. Such memory 1072 may generally be configured to store information accessible to the processor(s) 1071, including data 1073 that can be retrieved, manipulated, created, and/or stored by processor(s) 1071 and instructions 1074 that can be executed by the processor(s) 1071. In some embodiments, data 1073 may be stored in one or more databases.

Accordingly, more specifically, controller 1070 receives certain inputs and transmits certain outputs. For example, controller 1070 receives an input signal from touch-sensitive device 652 by operator commanding that work mechanism 110, 910, 913 be repositioned to a desired position, forms an adjustment module 1075 based on an algorithm and data 1073 stored in memory 1072 such as current actual position of work mechanism 110, 910, 913, and outputs a signal to work mechanism 110, 910, 913 based on adjustment module 1075. Stated another way, controller 1070 is configured to output an adjustment signal to work mechanism 110, 910, 913 to adjust an actual position of work mechanism 110, 910, 913 based at least partially on a respective desired position signal. Further, upon receipt of data 1073 associated with incoming video signals from rearview camera 154, controller 1070 forms a video module 1076 based on a video algorithm and incoming video data in memory 1072, and outputs a corresponding video signal to display apparatus 153. Further, upon receipt of payload weight signals, for example, from payload sensors 1069 in boom 111 and/or bucket 112, 212, controller 1070 forms a payload module 1077 based on payload weight data and any other payload data in memory 1072 (e.g., truck count), and outputs payload information to operator. Accordingly, controller 1070 selectively controls boom 111 and bucket 112, 212, work mechanism 910, and secondary work mechanism 913. Touchpad 151 can include controller 1070, or at least portions of controller 1070.

Pursuant to another aspect of the present invention, a plurality of machines (which can be referred to as machine 100 or work equipment 100, which can be wheel loader 100 and/or other types of construction equipment, as described above) can be on a particular construction site. These machines 100 can be of different sizes, can include the same or different attachments (for example, but not limited to, bucket 112, 212, snowplow 912, snow wing 913) or variously sized attachments (for example, buckets of a different size on another machine 100), and can be used for different applications relative to one another. As mentioned above, the operator can enter a variety of personalized settings (which can be referred to as operator settings) into touchpad 151 by way of touch-sensitive device 652 with respect to a particular work equipment 100, and such settings can be stored in controller 1070, which can be at least partially included in touchpad 151; such personalized settings include, but is not limited to, what is mentioned herein. Yet, each work equipment 100 can be operated by the same operator. In moving between work equipment 100 on a particular construction site (or, to work equipment 100 at a different construction site), the operator may wish to use certain ones of the personalize settings from one work equipment 100 to another work equipment 100 at the construction site (whether for similar or different applications), and/or may wish to use at least some different settings when switching to another work equipment 100. Yet, the operator may not wish to lose the operator's settings on a previously used work equipment 100 and thus have to reenter the operator's personalized settings when moving to another work equipment and/or when later returning to work equipment 100 that operator had previously used. The present invention advantageously enables the operator to save (store) a multiplicity of operator settings for a multiplicity of machines 100, and those operator settings can be transferred from one machine 100 to another, this ability to save and transfer such operator settings being achievable by way of touchpad 151. Stated another way, according to an embodiment of the present invention, controller 1070 of touchpad 151 is configured for receiving from touch-sensitive device 652 at least one operator setting, for storing therein the at least one operator setting, and for transferring the at least one operator setting to another of work equipment 100.

In this way, the operator of work equipment 100 can store operator's personalized settings in touchpad 151, settings with respect to, for example, how the operator prefers to operate a specific work equipment 100, and/or a specific work equipment 100 with a certain attachment, and/or to operate the specific work equipment 100 for a specific application. Any of this information can be stored in touchpad 151. Before the operator enters the operator settings, control system 150 can be configured such that touchpad 151 (by way of controller 1070) can access or otherwise receive and recognize the configuration of the particular work equipment 100 that the operator is using, for example, the type of work equipment 100 (for example, wheel loader), its model, its size, the linkage used (such as Z-bar linkage or a parallel linkage for a wheel loader), the number of valves employed in association with the attachments (such as for the boom of the wheel loader, and the specific attachment(s)). This kind of information can be displayed to operator on touch-sensitive device 652 for information purposes, and/or can affect certain decision points when inputting operator settings, for example, the speed of bucket curl and/or dump. Further, the operator input the operator settings by way of touch-sensitive device 652 and store the information in touchpad 151. In this way, the operator settings are saved for future use, such that the operator does not have to reenter this information later. Further, not only can the operator settings be saved within touchpad 151 (such as on a hard drive or solid state drive of touchpad 151), but operator can save this information to a removable memory device such as a USB memory stick, or to a cloud server. Further, the operator can transfer the operator settings from one work equipment 100 to another in various alternative ways. First, operator can remove touchpad 151 from one work equipment 100 (in this way, touchpad 151 is releasably coupled with mounting structure 642) and attach touchpad 151 to a mounting structure in the other work equipment 100; in this way, what is stored in touchpad 151 (the operator settings) moves with touchpad 151 and thus to the other work equipment 100. Second, operator can, as mentioned save the operator settings from touchpad 151 (or, at least, by way of touchpad 151) to a memory device such as a memory stick, detach the memory stick from touchpad 151, carry memory stick to another touchpad 151 of another work equipment 100, and thereby input the operator settings into the new work equipment 100. Third, when touchpads 151 of the various work equipment 100 are enabled with Wi-Fi, operator can transfer the operator settings from one work equipment 100 to another work equipment 100 wirelessly by way of Wi-Fi. Fourth, when touchpads 151 are equipped with cellular (mobile) technology, operator can transfer the operator settings from one work equipment 100 to another work equipment 100 wirelessly by way of cellular technology.

In use, an operator initially makes certain selections, which can be referred to as operator settings, touchpad 151 having already accessed (or otherwise received and recognized) the machine configuration of work equipment 100 (for example, size, linkage, number of valves) in which touchpad 151 is placed. For example, as discussed above, operator can set operator's preferred sensitivity settings, corresponding to speed of boom 111 and bucket 112, 212, and/or work mechanisms 910, 913. Further, operator can select the mode of operating work mechanism 110, 910, 913, namely, selecting which virtual mechanical control 756, 757, 758 the operator will be using to operate work mechanism 110. More specifically, operator selects whether operator wishes to use virtual joystick 756, virtual levers 757 with 2SAL configuration, virtual levers 758 with 3SAL configuration, and/or virtual auxiliary mechanical controls 883 (alternatively, virtual auxiliary mechanical controls 883 can be determined by controller 1070 depending upon the type of attachment(s) attached to wheel loader 100, 900). Operator can make this selection by pressing one, two, or three fingers 655 in the central section of touch-sensitive device 652, corresponding to virtual joystick 756, virtual levers 757 with 2SAL configuration, and virtual levers 758 with 3SAL configuration, respectively, in conjunction with controller 1070 sensing the number of auxiliary functions. Further, operator can set detents 782. Further, operator can drag and drop icons into individual ones of buttons 768 in the vertical array along the right-hand margin of touch-sensitive device 652. Further, operator can swipe right on touch-sensitive device 652 to obtain optional buttons 768 associated with additional auxiliary functions. When ready to operate wheel loader 100, 900, operator can place operator's thumb and/or the base of the palm in field 763 to unlock controls 756, 757, 758 and thereby enable movement of wheel loader 100, 900. To scoop up a load, lift boom 111, dump a load, and lower boom 111, open jaws 215, or perform any such related task, operator can use the selected virtual mechanical controls 756, 757, 758, 883 as discussed above.

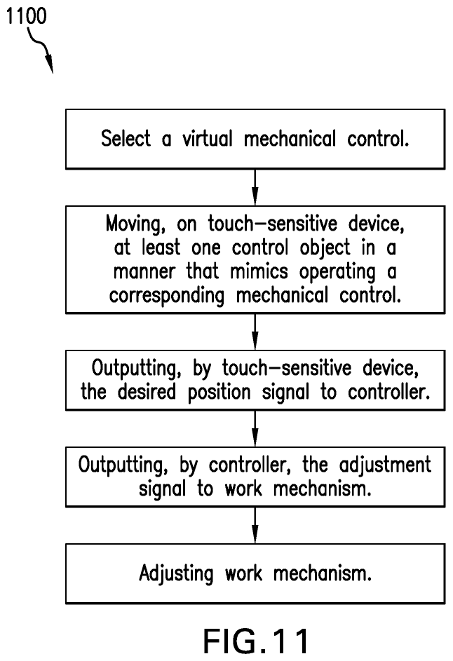

Referring now to FIG. 11, there is shown a flow diagram of a method 1100 of controllably performing work, according to an exemplary embodiment of the present invention. Method 1100 includes the steps of: outputting, by a touch-sensitive device 652, a desired position signal corresponding to a desired position of a work mechanism 110, 910 of work equipment 100, 900, touch-sensitive device 652 selectively operatively including a virtual mechanical control 756, 757, 758, 883 associated with producing the desired position signal; outputting, by controller 1070 operatively coupled to touch-sensitive device 652 and work mechanism 110, 910, an adjustment signal to work mechanism 110, 910 and thereby adjusting an actual position of work mechanism 110, 910 based at least partially on the desired position signal; and moving at least one control object 655 along touch-sensitive device 652 with respect to virtual mechanical control 756, 757, 758 in a manner that mimics operating a mechanical control 356, 457, 558, 374 and thereby outputting, by touch-sensitive device 652, the desired position signal to controller 1070. Work equipment 100 can be a wheel loader 100, work mechanism 100 including a boom 111 and a bucket 112, 212 coupled with boom 111, controller 1070 selectively controlling boom 111 and bucket 112, 212, mechanical control 356, 457, 558 being one of a first mechanical control 356 including a dual-axis joystick 356, a second mechanical control 457 including two single-axis levers 457, and a third mechanical control 558 including three single-axis levers 558, method 1100 further comprising the step of selecting, as virtual mechanical control 756, 757, 758, one of a first virtual mechanical control 756 corresponding to first mechanical control 356, a second virtual mechanical control 757 corresponding to second mechanical control 457, and a third virtual mechanical control 758 corresponding to third mechanical control 558. First virtual mechanical control 756 can be controlled by the at least one control object 655 which is at least one finger 655, second virtual mechanical control 757 can be controlled by the at least one control object 655 which is at least two fingers 655, and third virtual mechanical control 758 can be controlled by the at least one control object 655 which is at least three fingers 655. Touch-sensitive device 652 includes a plurality of selectable auxiliary controls 154, 769, virtual mechanical control 756, 757, 758 including at least one detent 782 which is activated when the at least one control object 655 slides along and double-taps touch-sensitive device 652. Controller 1070 is configured for receiving from touch-sensitive device 652 at least one operator setting, for storing therein the at least one operator setting, and for transferring the at least one operator setting to another of the work equipment 100. Work equipment 100, 900 can be a wheel loader 100, 900, mechanical control 356, 374 including a dual-axis joystick 356 and at least one auxiliary mechanical control 374, virtual mechanical control 756, 883 corresponding to mechanical control 356, 374 and thereby including a virtual dual-axis joystick 756 and at least one virtual auxiliary mechanical control 883 which are controlled by the at least one control object 655 which is at least one finger 655. Work equipment 900 can be a wheel loader 900, the work mechanism 910 being a primary work mechanism 910, the mechanical control 356, 457, 558 being a primary mechanical control 356, 457, 558 and being one of a first primary mechanical control 356 including a dual-axis joystick 356, a second primary mechanical control 457 including one of two single-axis levers 457 and two rollers 374, and a third primary mechanical 558 control including three single-axis levers 558, virtual mechanical control 756, 757, 758 being a virtual primary mechanical control 756, 757, 758 and selectively being one of a first primary virtual mechanical control 756 corresponding to first primary mechanical control 356, a second virtual primary mechanical control 757 corresponding to second primary mechanical control 457, and a third virtual primary mechanical control 758 corresponding to third primary mechanical control 558; wherein work equipment 900 can further include a secondary work mechanism 913, touch-sensitive device 652 outputting a desired secondary position signal corresponding to a position of secondary work mechanism 913, touch-sensitive device 652 selectively operatively including a virtual secondary mechanical control 756, 757, 758 associated with producing the desired secondary position signal of secondary work mechanism 913, controller 1070 operatively coupled to touch-sensitive device 652 and secondary work mechanism 913, controller 1070 outputting a secondary adjustment signal to secondary work mechanism 913 to adjust an actual position of secondary work mechanism 913 based at least partially on the desired secondary position signal; and one of: (a) wherein touch-sensitive device 652 outputs the desired secondary position signal to controller 1070 when the at least one control object 655 is moved along touch-sensitive device 652 with respect to virtual secondary mechanical control 756, 757, 758 in a manner that mimics operating a secondary mechanical control 356, 457, 558, 374, secondary mechanical control 356 being a dual-axis joystick 356, virtual secondary mechanical control 756 corresponding to secondary mechanical control 356; and (b) wherein touch-sensitive device 652 outputs the desired secondary position signal to controller 1070 when the at least one control object 655 is moved along touch-sensitive device 652 with respect to virtual secondary mechanical control 756, 757, 758. Work equipment 100, 900 can further include an operator's workstation 141, 941 which includes touch-sensitive device 652.

It is to be understood that the steps of the method of controllably performing work are performed by controller 1070 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by controller 1070 described herein, such as the method of controllably performing work, is implemented in software code or instructions which are tangibly stored on a tangible computer readable medium. The controller 1070 loads the software code or instructions via a direct interface with the computer readable medium or via a wired and/or wireless network. Upon loading and executing such software code or instructions by controller 1070, controller 1070 may perform any of the functionality of controller 1070 described herein, including any steps of the method of controllably performing work described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein, but is intended to include all changes and modifications that are within the scope and spirit of the invention.

What is claimed is:

1. A control system of a work equipment for controllably performing work, comprising:
a touch-sensitive device configured to output a desired position signal corresponding to a desired position of a work mechanism of the work equipment, the touch-sensitive device selectively operatively including a virtual mechanical control associated with producing the desired position signal; and
a controller operatively coupled to the touch-sensitive device and configured to operatively couple to the work mechanism, the controller configured to output an adjustment signal to the work mechanism to adjust an actual position of the work mechanism based at least partially on the desired position signal, the touch-sensitive device being configured to output the desired position signal to the controller when at least one control object is moved along the touch-sensitive device with respect to the virtual mechanical control in a manner that mimics operating a mechanical control.

2. The control system of claim 1, wherein the controller is configured to selectively control a boom and a bucket of the work equipment formed as a wheel loader, the mechanical control being one of a first mechanical control including a dual-axis joystick, a second mechanical control including two single-axis levers, and a third mechanical control including three single-axis levers, the virtual mechanical control selectively being one of a first virtual mechanical control corresponding to the first mechanical control, a second virtual mechanical control corresponding to the second mechanical control, and a third virtual mechanical control corresponding to the third mechanical control.

3. The control system of claim 2, wherein the first virtual mechanical control is configured for being controlled by the at least one control object which is at least one finger, the second virtual mechanical control is configured for being controlled by the at least one control object which is at least two fingers, and the third virtual mechanical control is configured for being controlled by the at least one control object which is at least three fingers.

4. The control system of claim 2, wherein the touch-sensitive device includes a plurality of selectable auxiliary controls, the virtual mechanical control including at least one detent configured for being activated when the at least one control object slides along and double-taps the touch-sensitive device.

5. The control system of claim 1, wherein the controller is configured for receiving from the touch-sensitive device at least one operator setting, for storing therein the at least one operator setting, and for transferring the at least one operator setting to another of the work equipment.

6. The control system of claim 1, wherein the controller is configured to selectively control the work equipment formed as a wheel loader, the mechanical control including a dual-axis joystick and at least one auxiliary mechanical control, the virtual mechanical control corresponding to the mechanical control and thereby including a virtual dual-axis joystick and at least one virtual auxiliary mechanical control which are configured for being controlled by the at least one control object which is at least one finger.

7. The control system of claim 1, wherein the controller is configured to selectively control the work equipment formed as a wheel loader, the work mechanism being a primary work mechanism, the mechanical control being a primary mechanical control and being one of a first primary mechanical control including a dual-axis joystick, a second primary mechanical control including one of two single-axis levers and two rollers, and a third primary mechanical control including three single-axis levers, the virtual mechanical control being a virtual primary mechanical control and selectively being one of a first primary virtual mechanical control corresponding to the first primary mechanical control, a second virtual primary mechanical control corresponding to the second primary mechanical control, and a third virtual primary mechanical control corresponding to the third primary mechanical control;
wherein the work equipment further includes a secondary work mechanism, the touch-sensitive device configured to output a desired secondary position signal corresponding to a position of the secondary work mechanism, the touch-sensitive device selectively operatively including a virtual secondary mechanical control associated with producing the desired secondary position signal of the secondary work mechanism, the controller operatively coupled to the touch-sensitive device and the secondary work mechanism, the controller configured to output a secondary adjustment signal to the secondary work mechanism to adjust an actual position of the secondary work mechanism based at least partially on the desired secondary position signal; and one of:
(a) wherein the touch-sensitive device is configured to output the desired secondary position signal to the controller when the at least one control object is moved along the touch-sensitive device with respect to the virtual secondary mechanical control in a manner that mimics operating a secondary mechanical control, the secondary mechanical control being a dual-axis joystick, the virtual secondary mechanical control corresponding to the secondary mechanical control; and
(b) wherein the touch-sensitive device is configured to output the desired secondary position signal to the controller when the at least one control object is moved along the touch-sensitive device with respect to the virtual secondary mechanical control.

8. A work equipment for controllably performing work, comprising:
a work mechanism;
a touch-sensitive device configured to output a desired position signal corresponding to a desired position of the work mechanism, the touch-sensitive device selectively operatively including a virtual mechanical control associated with producing the desired position signal; and
a controller operatively coupled to the touch-sensitive device and the work mechanism, the controller configured to output an adjustment signal to the work mechanism to adjust an actual position of the work mechanism based at least partially on the desired position signal, the touch-sensitive device being configured to output the desired position signal to the controller when at least one control object is moved along the touch-sensitive device with respect to the virtual mechanical control in a manner that mimics operating a mechanical control.

9. The work equipment of claim 8, wherein the work equipment is a wheel loader, the work mechanism including a boom and a bucket coupled with the boom, the controller configured to selectively control the boom and the bucket, the mechanical control being one of a first mechanical control including a dual-axis joystick, a second mechanical control including two single-axis levers, and a third mechanical control including three single-axis levers, the virtual mechanical control selectively being one of a first virtual mechanical control corresponding to the first mechanical control, a second virtual mechanical control corresponding to the second mechanical control, and a third virtual mechanical control corresponding to the third mechanical control.

10. The work equipment of claim 9, wherein the first virtual mechanical control is configured for being controlled by the at least one control object which is at least one finger, the second virtual mechanical control is configured for being controlled by the at least one control object which is at least two fingers, and the third virtual mechanical control is configured for being controlled by the at least one control object which is at least three fingers.

11. The work equipment of claim 9, wherein the touch-sensitive device includes a plurality of selectable auxiliary controls, the virtual mechanical control including at least one detent configured for being activated when the at least one control object slides along and double-taps the touch-sensitive device.

12. The work equipment of claim 8, further comprising an operator's workstation which includes the touch-sensitive device, the controller configured for receiving from the touch-sensitive device at least one operator setting, for storing therein the at least one operator setting, and for transferring the at least one operator setting to another of the work equipment.

13. The work equipment of claim 8, wherein the work equipment is a wheel loader, the mechanical control including a dual-axis joystick and at least one auxiliary mechanical control, the virtual mechanical control corresponding to the mechanical control and thereby including a virtual dual-axis joystick and at least one virtual auxiliary mechanical control which are configured for being controlled by the at least one control object which is at least one finger.

14. The work equipment of claim 8, wherein the work equipment is a wheel loader, the work mechanism being a primary work mechanism, the mechanical control being a primary mechanical control and being one of a first primary mechanical control including a dual-axis joystick, a second primary mechanical control including one of two single-axis levers and two rollers, and a third primary mechanical control including three single-axis levers, the virtual mechanical control being a virtual primary mechanical control and selectively being one of a first primary virtual mechanical control corresponding to the first primary mechanical control, a second virtual primary mechanical control corresponding to the second primary mechanical control, and a third virtual primary mechanical control corresponding to the third primary mechanical control;
wherein the work equipment further includes a secondary work mechanism, the touch-sensitive device configured to output a desired secondary position signal corresponding to a position of the secondary work mechanism, the touch-sensitive device selectively operatively including a virtual secondary mechanical control associated with producing the desired secondary position signal of the secondary work mechanism, the controller operatively coupled to the touch-sensitive device and the secondary work mechanism, the controller configured to output a secondary adjustment signal to the secondary work mechanism to adjust an actual position of the secondary work mechanism based at least partially on the desired secondary position signal; and one of:
(a) wherein the touch-sensitive device is configured to output the desired secondary position signal to the controller when the at least one control object is moved along the touch-sensitive device with respect to the virtual secondary mechanical control in a manner that mimics operating a secondary mechanical control, the secondary mechanical control being a dual-axis joystick, the virtual secondary mechanical control corresponding to the secondary mechanical control; and
(b) wherein the touch-sensitive device is configured to output the desired secondary position signal to the controller when the at least one control object is moved along the touch-sensitive device with respect to the virtual secondary mechanical control.

15. A method of controllably performing work by a work equipment, the method comprising the steps of:
outputting, by a touch-sensitive device, a desired position signal corresponding to a desired position of a work mechanism of the work equipment, the touch-sensitive device selectively operatively including a virtual mechanical control associated with producing the desired position signal;
outputting, by a controller operatively coupled to the touch-sensitive device and the work mechanism, an adjustment signal to the work mechanism and thereby adjusting an actual position of the work mechanism based at least partially on the desired position signal; and
moving at least one control object along the touch-sensitive device with respect to the virtual mechanical control in a manner that mimics operating a mechanical control and thereby outputting, by the touch-sensitive device, the desired position signal to the controller.

16. The method of claim 15, wherein the work equipment is a wheel loader, the work mechanism including a boom and a bucket coupled with the boom, the controller selectively controlling the boom and the bucket, the mechanical control being one of a first mechanical control including a dual-axis joystick, a second mechanical control including two single-axis levers, and a third mechanical control including three single-axis levers, the method further comprising the step of selecting, as the virtual mechanical control, one of a first virtual mechanical control corresponding to the first mechanical control, a second virtual mechanical control corresponding to the second mechanical control, and a third virtual mechanical control corresponding to the third mechanical control.

17. The method of claim 16, wherein the first virtual mechanical control is controlled by the at least one control object which is at least one finger, the second virtual mechanical control is controlled by the at least one control object which is at least two fingers, and the third virtual mechanical control is controlled by the at least one control object which is at least three fingers, the touch-sensitive device including a plurality of selectable auxiliary controls, the virtual mechanical control including at least one detent which is activated when the at least one control object slides along and double-taps the touch-sensitive device.

18. The method of claim 15, wherein the controller is configured for receiving from the touch-sensitive device at least one operator setting, for storing therein the at least one operator setting, and for transferring the at least one operator setting to another of the work equipment.

19. The method of claim 15, wherein the work equipment is a wheel loader, the mechanical control including a dual-axis joystick and at least one auxiliary mechanical control, the virtual mechanical control corresponding to the mechanical control and thereby including a virtual dual-axis joystick and at least one virtual auxiliary mechanical control which are controlled by the at least one control object which is at least one finger.

20. The method of claim 15, wherein the work equipment is a wheel loader, the work mechanism being a primary work mechanism, the mechanical control being a primary mechanical control and being one of a first primary mechanical control including a dual-axis joystick, a second primary mechanical control including one of two single-axis levers and two rollers, and a third primary mechanical control including three single-axis levers, the virtual mechanical control being a virtual primary mechanical control and selectively being one of a first primary virtual mechanical control corresponding to the first primary mechanical control, a second virtual primary mechanical control corresponding to the second primary mechanical control, and a third virtual primary mechanical control corresponding to the third primary mechanical control;
wherein the work equipment further includes a secondary work mechanism, the touch-sensitive device outputting a desired secondary position signal corresponding to a position of the secondary work mechanism, the touch-sensitive device selectively operatively including a virtual secondary mechanical control associated with producing the desired secondary position signal of the secondary work mechanism, the controller operatively coupled to the touch-sensitive device and the secondary work mechanism, the controller outputting a secondary adjustment signal to the secondary work mechanism to adjust an actual position of the secondary work mechanism based at least partially on the desired secondary position signal; and one of:
(a) wherein the touch-sensitive device outputs the desired secondary position signal to the controller when the at least one control object is moved along the touch-sensitive device with respect to the virtual secondary mechanical control in a manner that mimics operating a secondary mechanical control, the secondary mechanical control being a dual-axis joystick, the virtual secondary mechanical control corresponding to the secondary mechanical control; and
(b) wherein the touch-sensitive device outputs the desired secondary position signal to the controller when the at least one control object is moved along the touch-sensitive device with respect to the virtual secondary mechanical control.
